(19) United States
(12) Patent Application Publication
(10) Pub. No.: US 2025/0196125 A1
(43) Pub. Date: Jun. 19, 2025

(54) DISPOSABLE PIPETTE

(71) Applicant: SUMITOMO BAKELITE CO., LTD., Shinagawa-ku, Tokyo (JP)

(72) Inventor: Kohta Igarashi, Tokyo (JP)

(21) Appl. No.: 18/847,282

(22) PCT Filed: Mar. 3, 2023
(86) PCT No.: PCT/JP2023/007974

§ 371 Date: Sep. 16, 2024

(30) Foreign Application Priority Data
Mar. 24, 2022 (JP) 2022-048741

(51) Int. Cl. B01L 3/02

(52) U.S. Cl. CPC B01L 3/0213; B01L 2300/0681

(57) ABSTRACT

An object of the present invention is to provide a disposable pipette capable of avoiding mixing foreign matter into a sample. The disposable pipette of the present invention is a disposable pipette used in a medical field or a biochemical field, and includes a resin-made pipette main body having a connection portion connected to a suction device, and a resin filter inserted into the connection portion. In the resin filter, an elution amount, in a case where the resin filter is subjected to radiation exposure such that an absorbed dose is 20 kGy or more, is equivalent to a maximum absorbance of 0.08 or less in a wavelength range of 220 nm to 241 nm and is equivalent to a maximum absorbance of 0.05 or less in a wavelength range of 241 nm to 350 nm.

### TECHNICAL FIELD

The present invention relates to a disposable pipette.

### BACKGROUND ART

A resin-made disposable pipette is used. An example of such a disposable pipette is disclosed in, for example, Japanese Unexamined Utility Model Application, First Publication No. S63-90438 (Patent Literature 1). In the disposable pipette of Patent Literature 1, a cotton plug is inserted into a connection portion between a suction device in a resin-made pipette main body in order to facilitate the control of a dropping amount of a sample.

Examples of a use of the resin-made disposable pipette include weighing, dispensing, or the like of a solution in experiments and tests in a medical field or a biochemical field. In such a use, it is required to strictly avoid mixing foreign matter into the sample, but in a case where the cotton plug is inserted into the connection portion of the pipette main body as in Patent Literature 1, there was a possibility that a part of the fibers constituting the cotton plug may be mixed into the sample.

### CITATION LIST

### Patent Literature

[PTL 1] Japanese Unexamined Utility Model Application, First Publication No. S63-90438

### SUMMARY OF INVENTION

### Technical Problem

There is a demand for realizing a disposable pipette capable of avoiding mixing foreign matter into a sample.

### Solution to Problem

The disposable pipette according to the present invention is a disposable pipette used in a medical field or a biochemical field, and includes a resin-made pipette main body having a connection portion connected to a suction device, and a resin filter in which, in a case where the resin filter is inserted into the connection portion and is subjected to radiation exposure such that an absorbed dose is 20 kGy or more, an elution amount measured in accordance with a plastic drug container test method eluate test of Pharmacopoeia of Japan is equivalent to a maximum absorbance of 0.08 or less in a wavelength range of 220 nm to 241 nm and is equivalent to a maximum absorbance of 0.05 or less in a wavelength range of 241 nm to 350 nm.

With this configuration, since the resin filter is inserted into the connection portion of the resin-made pipette main body, unlike the case where the cotton plug is inserted, for example, there is no concern that the fibers derived from the cotton plug are mixed into the sample as foreign matters. In addition, in a case where the disposable pipette is used in the medical field or the biochemical field, the disposable pipette is often subjected to radiation exposure for sterilization treatment, but even in such a case, the elution from the resin filter is suppressed to an extremely small amount. Therefore, it is possible to realize the disposable pipette that can avoid mixing foreign matter into the sample, tolerable for use in a medical field or a biochemical field.

Hereinafter, suitable aspects of the present invention will be described. However, the scope of the present invention is not limited by the suitable examples of the aspects described below.

As one aspect, it is preferable that the elution amount, in a case where the resin filter is subjected to radiation exposure such that an absorbed dose is 70 kGy or more, is equivalent to a maximum absorbance of 0.08 or less in the wavelength range of 220 nm to 241 nm and is equivalent to a maximum absorbance of 0.05 or less in the wavelength range of 241 nm to 350 nm.

With this configuration, even in a case where a more powerful sterilization treatment is performed, the elution from the resin filter is suppressed to an extremely small amount. Therefore, it is possible to more reliably avoid mixing foreign matter into the sample while improving the aseptic property.

As one aspect, it is preferable that the resin filter is a porous resin sintered filter.

With this configuration, by using the porous resin sintered filter, the elution from the resin filter can be further reduced. In addition, for example, by adjusting a size of a void, a void ratio, or the like, the ventilation resistance can be easily optimized.

As one aspect, it is preferable that the resin filter is made of a polyethylene-based resin or a polypropylene-based resin.

With this configuration, by using any of the polyethylene-based resin or the polypropylene-based resin having relatively high radiation resistance, the elution from the resin filter after the sterilization treatment can be further suppressed to an extremely small amount. Therefore, it is possible to more reliably avoid mixing foreign matter into the sample.

Further features and advantages of the present invention will be apparent from the following exemplary and non-limited description of embodiments with reference to the drawings.

### BRIEF DESCRIPTION OF DRAWINGS

FIG. 1 is a schematic diagram of a pipette according to an embodiment.

FIG. 2 is an enlarged cross-sectional view in the vicinity of a connection portion of a pipette main body.

### DESCRIPTION OF EMBODIMENTS

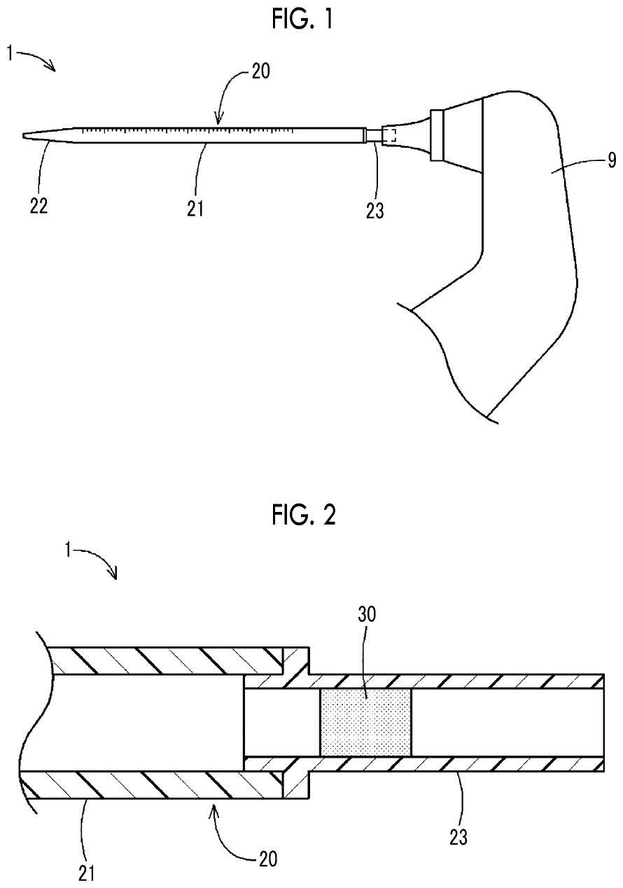

An embodiment of the pipette will be described with reference to the drawings. A pipette 1 according to the present embodiment is a disposable pipette that is intended to be discarded after each use. As shown in FIG. 1, the pipette 1 includes a pipette main body 20. The pipette main body 20 includes a main body portion 21, a tip end portion 22 provided at one end of the main body portion 21, and a connection portion 23 provided at the other end of the main body portion 21.

The main body portion 21 is formed in a cylindrical shape. The size of the main body portion 21 is not particularly limited. A length of the main body portion 21 can be, for example, 100 to 500 mm, and an inner diameter thereof can be, for example, 2 to 20 mm. In addition, the capacity of the main body portion 21 can be, for example, 1 to 500 mL. A scale for indicating a suction-retained liquid amount may be attached to an outer surface of the main body portion 21.

The tip end portion 22 is formed in a truncated conical shape. The tip end portion 22 is formed to gradually reduce the diameter toward the tip end portion on a side opposite to the main body portion 21 with a side of the main body portion 21 as a base end portion. The size of the tip end portion 22 is not particularly limited. The length of the tip end portion 22 can be, for example, 5 to 30 mm. In addition, the inner diameter of the tip end opening portion of the tip end portion 22 can be, for example, 0.1 to 3 mm.

The connection portion 23 is formed in a cylindrical shape. The connection portion 23 is formed in a cylindrical shape that is one size smaller than the main body portion 21. The size of the connection portion 23 is not particularly limited. A length of the connection portion 23 can be, for example, 10 to 30 mm, and an inner diameter thereof can be, for example, 2 to 10 mm. The connection portion 23 is connected to a suction device 9 at an end portion on a side opposite to the main body portion 21.

The suction device 9 is a device for suctioning a liquid into the pipette main body 20 from the side of the tip end portion 22. The suction device 9 may be, for example, an automatic suction device such as a pipette, or may be, for example, a manual suction device such as a pipette cap (rubber ball).

The pipette main body 20 is made of a resin suitable for disposable use. A resin material constituting the pipette main body 20 is not particularly limited, but it is preferable to use a material having high transparency and excellent moldability. The pipette main body 20 can be formed by using polyethylene, polypropylene, cyclic polyolefin, polyester, polystyrene, polycarbonate, polymethylpentene, and the like, for example.

The pipette main body 20 can be formed by, for example, extrusion molding, injection molding, or the like. In this case, for example, the main body portion 21 and the tip end portion 22 may be integrally formed, the connection portion 23 may be formed separately from the main body portion 21 and the tip end portion 22, and these two components may be joined to each other to be configured. The two components can be joined by, for example, thermal welding, laser welding, ultrasonic welding, and adhesion with an adhesive or a pressure sensitive adhesive.

As shown in FIG. 2, the pipette 1 according to the present embodiment includes a pipette main body 20 and a resin filter 30. The resin filter 30 is inserted into the connection portion 23 of the pipette main body 20. By providing the resin filter 30 in the connection portion 23, it is possible to suppress mixing foreign matter from the suction device 9 into the side of the pipette main body 20. In addition, for example, even in a case where the liquid is excessively suctioned by the suction device 9 and the like, it is possible to suppress the contamination or the damage of the suction device 9. The resin filter 30 is incorporated into the connection portion 23 of the pipette main body 20.

In the present embodiment, a porous resin sintered filter is used as the resin filter 30. Here, the porous resin sintered filter is a filter formed of a porous resin sintered body having continuous voids, and is a filter formed of a sintered body obtained by putting particles of a material resin into a mold and heating the particles in a pressurized state. A resin material constituting the resin filter 30 (in the present example, porous resin sintered filter) is not particularly limited, and various thermoplastic resins can be preferably used. Examples of the thermoplastic resin include low-density polyethylene, high-density polyethylene, ultrahigh molecular weight polyethylene, polymethyl methacrylate, polypropylene, an ethylene-vinyl acetate copolymer, polystyrene, polyamide, polycarbonate, and the like. Among these, a polyethylene-based resin (for example, low-density polyethylene, ethylene-vinyl acetate copolymer, or the like) or a polypropylene-based resin can be preferably used.

An average pore diameter (size of continuous voids) of the resin filter 30 (porous resin sintered filter) is not particularly limited, but can be, for example, 1 to 10 μm. In addition, a porosity (void ratio) of the resin filter 30 (porous resin sintered filter) is not particularly limited, but can be, for example, 20% to 50%. In addition, the length and the outer diameter of the resin filter 30 are not particularly limited, but for example, the length can be 5 to 10 mm and the outer diameter can be 2 to 10 mm.

In the resin filter 30 according to the present embodiment, the elution amount in a case where the resin filter 30 is subjected to radiation exposure such that the absorbed dose is 20 kGy or more satisfies the following conditions. Here, the elution amount of the resin filter 30 means an elution amount measured in accordance with the plastic drug container test method eluate test of Pharmacopoeia of Japan (7.02.1.2). The elution amount of the resin filter 30 is equivalent to a maximum absorbance of 0.08 or less in the wavelength range of 220 to 241 nm and is equivalent to a maximum absorbance of 0.05 or less in the wavelength range of 241 to 350 nm with respect to the absorbance calculated from the ultraviolet absorption spectrum. By using the resin filter 30 satisfying such conditions, the elution amount from the resin filter 30 can be suppressed to an extremely small amount suitable for use in the medical field or the biochemical field.

It is preferable that, in the resin filter 30, the elution amount, in a case where the resin filter 30 is subjected to radiation exposure under stronger conditions such that the absorbed dose is 70 kGy or more, is the same equivalent amount as described above. That is, it is preferable that the elution amount of the resin filter 30 is equivalent to the maximum absorbance of 0.08 or less in the wavelength range of 220 to 241 nm and the maximum absorbance of 0.05 or less in the wavelength range of 241 to 350 nm even in a case where the resin filter 30 is subjected to radiation exposure such that the absorbed dose is 20 kGy or more. By using the resin filter 30 satisfying such conditions, the elution amount can be suppressed to an extremely small amount even in a case where the radiation exposure is performed under stronger conditions.

Alternatively, in the resin filter 30, it is preferable that the elution amount, in a case where the resin filter 30 is subjected to radiation exposure such that the absorbed dose is 20 kGy or more, is equivalent to a maximum absorbance of 0.07 or less in the wavelength range of 220 to 241 nm and is equivalent to a maximum absorbance of 0.04 or less in the wavelength range of 241 to 350 nm. In addition, in the resin filter 30, it is more preferable that the elution amount in a case where the resin filter 30 is subjected to radiation exposure under the same conditions is equivalent to a maximum absorbance of 0.06 or less in the wavelength range of 220 to 241 nm and is equivalent to a maximum absorbance of 0.03 or less in the wavelength range of 241 to 350 nm.

Furthermore, in the resin filter 30, it is more preferable that the elution amount in a case where the resin filter 30 is subjected to radiation exposure under stronger conditions such that the absorbed dose is 70 kGy or more is equivalent to a maximum absorbance of 0.07 or less in the wavelength range of 220 to 241 nm and is equivalent to a maximum absorbance of 0.04 or less in the wavelength range of 241 to 350 nm. In addition, in the resin filter 30, it is further more preferable that the elution amount in a case where the resin filter 30 is subjected to radiation exposure under the same conditions is equivalent to a maximum absorbance of 0.06 or less in the wavelength range of 220 to 241 nm and is equivalent to a maximum absorbance of 0.03 or less in the wavelength range of 241 to 350 nm. In this case, the elution amount from the resin filter 30 can be further suppressed to an extremely small amount even in a case where the radiation exposure is performed under a stronger condition.

The pipette 1 according to the present embodiment can be used, for example, for weighing, dispensing, or the like of various solutions in experiments and tests in the medical field or the biochemical field. Therefore, the pipette 1 according to the present embodiment is subjected to sterilization treatment by radiation exposure after the production. From a viewpoint of ensuring the aseptic property, the radiation exposure for the sterilization treatment is preferably performed such that the absorbed dose is 20 kGy or more, more preferably performed such that the absorbed dose is 25 kGy or more, and further more preferably performed such that the absorbed dose is 70 kGy or more. By performing the sterilization treatment under a stronger condition, the aseptic property of the pipette 1 can be improved. In addition, even in a case where such a sterilization treatment is performed, it is possible to avoid mixing eluates derived from the resin filter 30.

Hereinafter, a plurality of test examples will be shown to describe the present invention in more detail. However, the scope of the present invention is not limited by specific examples described below.

### Test Example 1

A polyester-made resin filter 30 was prepared. The resin filter 30 was produced by sintering polyester fibers. The obtained resin filter 30 had an outer diameter of 4.3 mm and a length of 10 mm. The resin filter 30 was irradiated with an electron beam so that an absorbed dose thereof was 70 kGy.

The resin filter 30 after the electron beam irradiation was used as a specimen, and the foaming, the pH, the potassium permanganate reducing substance, the ultraviolet absorption spectrum, and the evaporation residue were measured in accordance with “1.2 Eluate Test” of “7.02 the Plastic Drug Container Test Method” in General Test Methods of the 18th Revised Edition of Pharmacopoeia of Japan. The extraction temperature and the extraction time were each set to 50° C. and 72 hours. In addition, regarding the ultraviolet absorption spectrum, each of a maximum absorbance in a wavelength range of 220 to 241 nm and a maximum absorbance in a wavelength range of 241 to 350 nm was measured.

### Test Example 2

A resin filter 30 made of low-density polyethylene was prepared. The resin filter 30 was produced by filling a mold with low-density polyethylene particles having an average particle diameter of 400 μm and pressing the particles. The obtained resin filter 30 had the same size as in Test Example 1, and an average pore size of 30 μm. The resin filter 30 was irradiated with an electron beam under the same conditions as in Test Example 1. The resin filter 30 after the electron beam irradiation was used as a specimen, and the foaming, the pH, the potassium permanganate reducing substance, the ultraviolet absorption spectrum, and the evaporation residue were measured in the same manner as in Test Example 1.

### Test Example 3

A resin filter 30 made of an ethylene-vinyl acetate copolymer was prepared. The resin filter 30 was produced by filling a mold with ethylene-vinyl acetate copolymer particles having an average particle diameter of 300 μm and pressing the particles. The obtained resin filter 30 had the same size as in Test Example 1, and an average pore size of 30 μm. The resin filter 30 was irradiated with an electron beam under the same conditions as in Test Example 1. The resin filter 30 after the electron beam irradiation was used as a specimen, and the foaming, the pH, the potassium permanganate reducing substance, the ultraviolet absorption spectrum, and the evaporation residue were measured in the same manner as in Test Example 1.

The measurement results are shown in Table 1 below.

TABLE 1

| | | | Test Example 1 | Test Example 2 | Test Example 3 |
|---|---|---|---|---|---|
| Material | | | PEs | LDPE | EVA |
| Eluate | Foaming | | Disappear within 3 minutes | Disappear within 3 minutes | Disappear within 3 minutes |
| Test | pH | | Difference 1.3 | Difference 0.5 or less | Difference 1.5 |
| | Potassium permanganate | | Difference 0.5 mL or less | Difference 0.5 mL or less | Difference 0.9 mL |
| | reducing substance | | | | |
| | Ultraviolet | 220 to 241 nm | 0.16 (240 nm) | 0.01 or less | 0.05 (220 nm) |
| | absorption | 241 to 350 nm | 0.16 (242 nm) | 0.01 or less | 0.02 (241 nm) |
| | spectrum | | | | |

| | | | |
|---|---|---|---|
| Evaporation residue | 1.0 mg or less | 1.0 mg or less | 1.0 mg or less |

From these results, it was confirmed that in the resin filters 30 of Test Examples 2 and 3 using a low-density polyethylene or ethylene-vinyl acetate copolymer as the material, the elution amount was suppressed to an extremely small amount that sufficiently conformed to the standard of a plastic aqueous syringe container. In addition, in a case where these resin filters 30 were inserted into the connection portion 23 of the pipette main body 20 and used for a trial, it was not confirmed that any foreign matter was mixed into a test solution to be handled.

Hereinabove, the pipette according to the present invention has been described in detail with reference to specific embodiments and test examples, but the present invention is not limited thereto. The embodiment described in the present specification is provided as an example in all aspects, and can be appropriately modified within a range of not departing from the gist of the present invention.

### INDUSTRIAL APPLICABILITY

According to the present invention, even in a case where a more powerful sterilization treatment is performed, the elution from the resin filter is suppressed to an extremely small amount, and thus it is possible to provide a disposable pipette capable of more reliably avoiding mixing foreign matter into a sample while improving the aseptic property.

### REFERENCE SIGNS LIST

1: pipette
9: suction device
20: pipette main body
21: main body portion
22: tip end portion
23: connection portion
30: resin filter

What is claim is:

1. A disposable pipette used in a medical field or a biochemical field, the disposable pipette comprising:
a resin-made pipette main body having a connection portion connected to a suction device; and
a resin filter in which, in a case where the resin filter is inserted into the connection portion and is subjected to radiation exposure such that an absorbed dose is 20 kGy or more, an elution amount measured in accordance with a plastic drug container test method eluate test of Pharmacopoeia of Japan is equivalent to a maximum absorbance of 0.08 or less in a wavelength range of 220 nm to 241 nm and is equivalent to a maximum absorbance of 0.05 or less in a wavelength range of 241 nm to 350 nm.

2. The disposable pipette according to claim 1,
wherein the elution amount, in a case where the resin filter is subjected to radiation exposure such that an absorbed dose is 70 kGy or more, is equivalent to a maximum absorbance of 0.08 or less in the wavelength range of 220 nm to 241 nm and is equivalent to a maximum absorbance of 0.05 or less in the wavelength range of 241 nm to 350 nm.

3. The disposable pipette according to claim 1,
wherein the resin filter is a porous resin sintered filter.

4. The disposable pipette according to claim 1,
wherein the resin filter is formed of a polyethylene-based resin or a polypropylene-based resin.

5. The disposable pipette according to claim 2,
wherein the resin filter is formed of a polyethylene-based resin or a polypropylene-based resin.

6. The disposable pipette according to claim 3,
wherein the resin filter is formed of a polyethylene-based resin or a polypropylene-based resin.
